(19) United States
(12) Patent Application Publication
(10) Pub. No.: US 2013/0262308 A1
(43) Pub. Date: Oct. 3, 2013

(54) SPENDING LIMITS FOR OFFLINE CHARGING

(71) Applicants: Yigang Cai, Naperville, IL (US); Ranjan Sharma, New Albany, OH (US)

(72) Inventors: Yigang Cai, Naperville, IL (US); Ranjan Sharma, New Albany, OH (US)

(21) Appl. No.: 13/438,265

(22) Filed: Apr. 3, 2012

(51) Int. Cl. G06Q 20/40

(52) U.S. Cl. 705/44

(57) ABSTRACT

Systems and methods that provide spending limits for offline charging. In one embodiment, an offline charging system monitors usage of an end user over a packet core network, and identifies a spending limit that the end user is allowed to consume during a time period, such as a billing cycle. The offline charging system determines that the usage of the end user is approaching the spending limit during a session, identifies options for the end user to continue with the session as the usage of the end user approaches the spending limit, and initiates a notification to the end user indicating the options. The offline charging system receives a response from the end user selecting one of the options, and conveys the selected option to a network element in the packet core network that modifies policies for the session.

### FIELD OF THE INVENTION

The invention is related to the field of communication systems and, in particular, to spending limits within communication networks, such as a Long Term Evolution (LTE) network.

### BACKGROUND

Service providers typically provide numerous voice and data services to end users (also referred to as subscribers). Examples of voice services are voice calls, call forwarding, call waiting, etc. Examples of data services are streaming audio, streaming video, Voice over Internet Protocol (VoIP), online gaming, and IP-TV. The data services are managed by a packet core network, which interfaces the end user with external Packet Data Networks (PDN), such as the Internet. Some examples of packet core networks are a General Packet Radio Service (GPRS) core network, an Evolved Packet Core (EPC) of a Long Term Evolution (LTE) network, etc. Mobile devices, such as cell phones, personal data assistants, smart phones, notebook computers, etc, may access the data services provided by the networks over an air interface with one or more base stations.

The popularity of data services and the speeds at which packet core networks can provide them has created a situation where the sessions that are established over packet core networks are typically longer than traditional voice calls placed over a circuit-switched network. For example, online gaming sessions, IP-TV sessions, etc., can easily last for an hour or more where a voice call is typically less than 10 minutes. Because of the length of these data sessions, subscribers may be at risk for “bill shock” when they receive their monthly billing statements, as the amounts in the billing statements may be much higher than expected. A subscriber may have a service plan that allows for 10 Gigabytes of data for a monthly fee (e.g., $50). If the subscriber uses more than the allotted bandwidth over the month, then the bill for that month can be much higher than the expected monthly fee. Network operators would like to avoid such situations.

### SUMMARY

Embodiments described herein provide for spending limits defined within an offline charging system. The offline charging system is able to monitor usage of an end user over a time period, such as a billing cycle. If the end user's usage approaches a spending limit, then the offline charging system alerts the end user and provides the end user with options for continuing with the session. For example, one option may be to downgrade the QoS for the session before the spending limit is reached. The offline charging system then conveys the selected option and other spending limit information to a network node that modifies the session.

Because offline charging allows services to be provided to end users before charging for the services (as opposed to online charging), the bills for offline charging subscribers can grow quickly within a billing cycle without the subscribers being aware. The spending limits defined in the offline charging system help to avoid the scenario where end users exceed a particular usage during a billing cycle, and receive an excessive bill at the end of the billing cycle.

In one embodiment, an offline charging system is configured to monitor usage of an end user over a packet core network based on (offline) accounting information, and to identify a spending limit that the end user is allowed to consume during a time period. The offline charging system is further configured to determine that the usage of the end user is approaching the spending limit during a session, to identify options for the end user to continue with the session as the usage of the end user approaches the spending limit, and to initiate a notification to the end user indicating the options. The offline charging system is further configured to receive a response from the end user selecting one of the options, and to convey the selected option to a network element in the packet core network that modifies policies for the session based on the selected option.

In another embodiment, the options provided to the end user may include one or more of downgrading a Quality of Service (QoS) for the session at the same rate or a lower rate, upgrading the QoS for the session at a higher rate, maintaining the QoS for the session at a higher rate, and maintaining the QoS for the session at the same rate.

In another embodiment, the offline charging system is implemented in a Policy and Charging Control (PCC) architecture, such as for an LTE network. The offline charging system connects to a Policy and Charging Rules Function (PCRF), such as over a Diameter Sy interface or another suitable interface. The offline charging system is configured to monitor usage of an end user, to identify a spending limit that the end user is allowed to consume during a time period, to determine that the usage of the end user is approaching the spending limit during a session, to identify options for the end user to continue with the session as the usage of the end user approaches the spending limit, and to initiate a notification to the end user indicating the options. The offline charging system is further configured to receive a response from the end user selecting one of the options, and to convey the selected option to the PCRF to modify Policy and Charging Control (PCC) rules for the session.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIG. 2 is a flow chart illustrating a method of performing spending control for offline charging in an exemplary embodiment.

FIG. 3 illustrates a PCC architecture for a packet core network in an exemplary embodiment.

FIG. 4 illustrates an LTE network using the PCC architecture of FIG. 3 in an exemplary embodiment.

FIG. 5 is a message diagram illustrating an example of spending limit control for offline charging in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

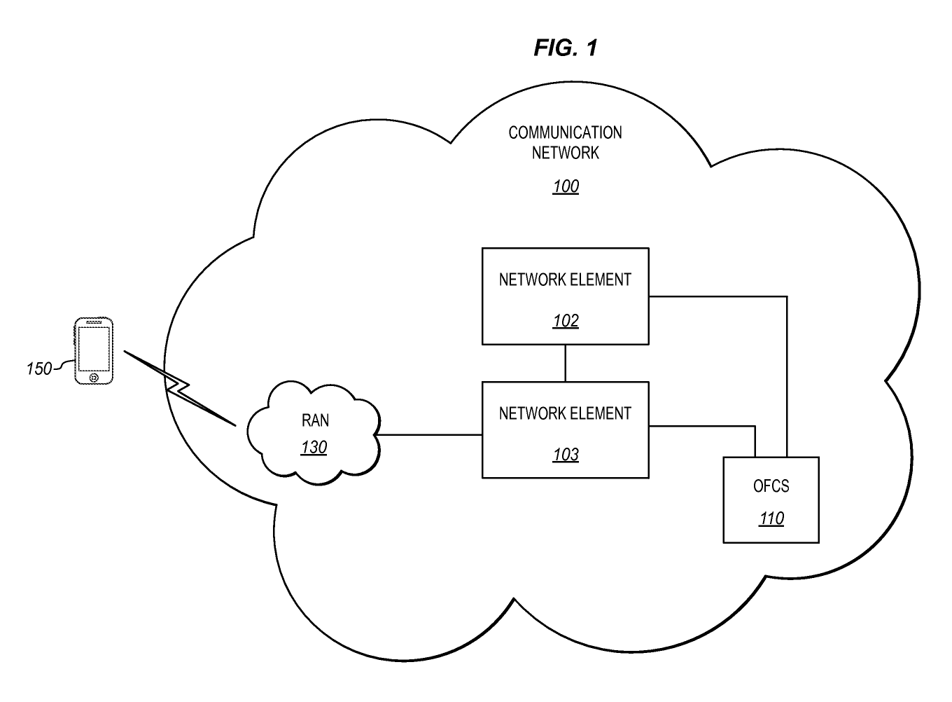

FIG. 1 illustrates a communication network 100 in an exemplary embodiment. Communication network 100 may be a packet-switched network, a circuit-switched network, an Internet Protocol (IP) Multimedia Subsystem (IMS) network, or another type of 3GPP network. Network 100 includes network elements 102-103. Network element 102 comprises any system, server, or function operable to provide policy control for sessions over network 100. One example of network element 102 is a Policy and Charging Rules Function (PCRF) of a Long Term Evolution (LTE) network. Network element 103 comprises any system, server, or function operable to enforce policies for sessions. One example of network element 103 is a Policy and Charging Enforcement Function (PCEF) of an LTE network. Although two network elements are shown in FIG. 1, the functionality of these two elements could be combined into a single element.

Network 100 also includes an Offline Charging System (OFCS) 110. OFCS 110 comprises any system, server, or function operable to provide offline charging for services/sessions accessed by end users, such as the end user of UE 150. Offline charging is a process where charging information for network resource usage is collected concurrently with resource usage. The charging information is then passed through a chain of logical charging functions so that Charging Data Records (CDR) may be generated. The CDRs are transferred to the network operator's billing domain for subscriber billing and/or inter-operator accounting.

When in operation, OFCS 110 receives accounting requests from network elements for a session, such as network element 103. OFCS 110 aggregates the accounting requests for the session to generate one or more CDRs for the session. OFCS 110 may be comprised of a Charging Data Function (CDF) and a Charging Gateway Function (CGF) as defined by the 3GPP in TS 32.240 (Release 6). The CDF receives one or more charging events, such as in Diameter Accounting Requests (ACR), from Charging Trigger Functions (CTF) in other network elements. The CDF then aggregates the charging events and uses the information contained in the charging events to build CDRs for the session. The CDRs generated by the CDF are transferred to the CGF. The CGF acts as a gateway between the network and the billing domain. The CGF consolidates the CDRs for the session to generate a consolidated CDR, which is conveyed to the billing domain.

UE 150 is able to access voice services, data services, etc., that are provided by network 100. Some examples of data services provided by network 100 are streaming audio, streaming video, Voice over IP (VoIP), online gaming, and IP-TV. UE 150 accesses network 100 through a Radio Access Network (RAN) 130. RAN 130 comprises a wireless network (e.g., cellular network, WiFi network, etc.) that provides UE 150 access to network 100 through wireless signals. In this embodiment, UE 150 may be communicating with a home network, or may be roaming in a visited network.

Embodiments provided herein allow for one or more spending limits to be defined for an end user in OFCS 110. A spending limit is a usage limit (e.g., monetary, volume, duration, etc.) that a subscriber is allowed to consume during a period of time. The time period may be a billing cycle, such as a month. Other shorter or longer time periods may also be utilized. For example, an end user (also referred to as a subscriber) may have a spending limit of $100 per billing cycle. In addition to the spending limit, one or more spending thresholds may be defined for end users that are less than the spending limit. When one or more of the spending thresholds (i.e., usage thresholds) are reached, the usage is “approaching” the spending limit (i.e., usage limit). For example, if the spending limit per billing cycle is $100, then a spending threshold may be $80, $90, etc. In another example, the spending limit may be 10 Gigabytes of data per billing cycle. In this example, the spending thresholds may be 8 Gigabytes of data, 9 Gigabytes of data, etc. The spending thresholds are indicators that usage is approaching a spending limit defined for an end user. The spending limits and spending thresholds may be stored in OFCS 110, such as in a charging profile for the end user.

OFCS 110 also maintains one or more usage counters (also referred to as policy counters) for the end user. The usage counter tracks the usage of the end user over a time period. OFCS 110 therefore monitors the usage of the end user during the billing cycle based on accounting information provided by the network elements for sessions established during the billing cycle.

In FIG. 1, assume that UE 150 registers with network 100 in order to receive services from network 100. At some point, UE 150 requests a session to stream audio, stream video, place a VoIP voice call, play an online game, watch IP-TV, etc., each of which involves a flow of packets referred to as a data flow. These types of sessions and services are referred to generally as data services.

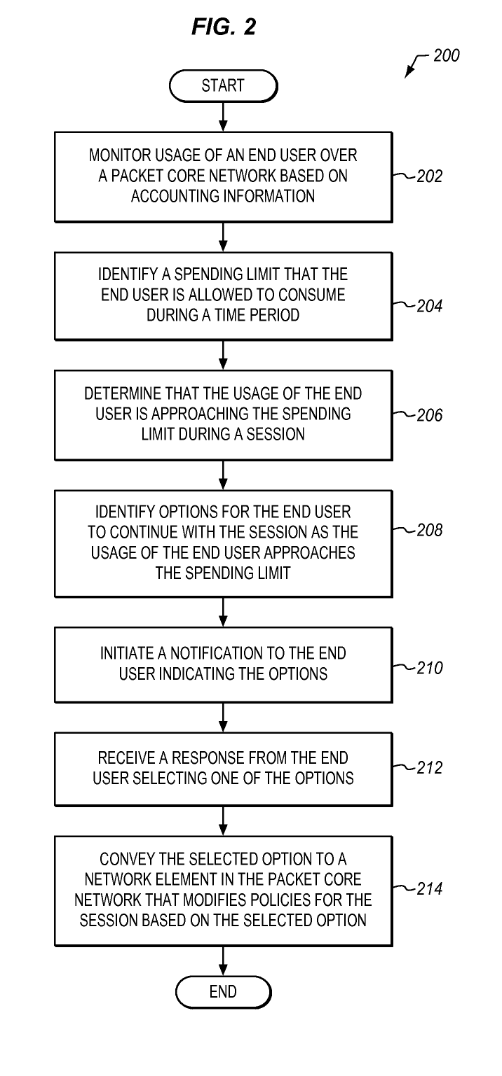

Another assumption is that an end user of UE 150 subscribes to offline charging. Therefore, as network element 103 and other network elements serve the session, the network elements send accounting requests to OFCS 110 to provide charging information to OFCS 110. OFCS 110 is able to control spending for the end user as is shown in FIG. 2.

FIG. 2 is a flow chart illustrating a method 200 of performing spending control for offline charging in an exemplary embodiment. The steps of method 200 will be described with reference to communication network 100 in FIG. 1, although method 200 may be performed in other networks or systems. The steps of the flow chart described herein are not all inclusive and may include other steps not shown. The steps may also be performed in an alternative order.

In step 202, OFCS 110 monitors usage of the end user based on (offline) accounting information received from network elements, such as network element 103. When the usage of the end user is described in this specification and the claims, it may refer to the end user and/or the end user device, such as UE 150. OFCS 110 monitors the usage over a time period by incrementing a counter based on the usage of the end user during the time period. In step 204, OFCS 110 identifies a spending limit that the end user is allowed to consume during a time period. OFCS 110 may store a charging profile for the end user that defines the spending limit. OFCS 110 may provide a user interface, such as a web interface, that allows the end user to specify the spending limit and adjust the spending limit as desired. In step 206, OFCS 110 determines that the usage of the end user is approaching the spending limit during a session. When the usage is “approaching” the spending limit, the usage is nearing or coming close to a spending limit by some amount. As stated above, there may be one or more spending thresholds defined along with the spending limit that are less than the spending limit. If the usage of the end user reaches a spending threshold during a session, then OFCS 110 is able to determine that the usage is approaching the spending limit and acts appropriately.

In step 208, OFCS 110 identifies options for the end user to continue with the session as the usage of the end user approaches the spending limit. One option is for the end user to continue with the session in its present form. The end user is alerted that usage is approaching the spending limit and is made aware that the bill for this billing cycle may be higher than normal. Another option is to downgrade or throttle the Quality of Service (QoS) for the session (at the same rate or at a reduced rate). QoS refers to a certain level of performance for a data flow that is provided or guaranteed by a network under the subscription of the end user. For example, the level of performance may include a bit rate, delay, jitter, packet dropping probability, and/or bit error rate. QoS throttling thus refers to reducing or downgrading the QoS provided or guaranteed to a mobile device of an end user when usage of the mobile device approaches a spending threshold. QoS throttling may be performed one or more times until a spending limit is reached, which results in the data services to the mobile device possibly being terminated. Another option is upgrade or maintain the QoS for the session at a higher rate. There may be multiple other options available to an end user when a spending limit is near.

In step 210, OFCS 110 initiates a notification to the end user indicating the options available to continue with the session. For example, OFCS 110 may contact a notification server (not shown in FIG. 1) to send the notification to the end user based on content provided by OFCS 110. In addition to the options for continuing with the session, the notification may also indicate a total usage (e.g., monetary, volume, duration) for the present billing cycle, a present rate for the session, a present QoS for the session, a future rate for the session if the spending limit is reached, a future QoS for the session if the spending limit is reached, etc. There may be stepped changes in rate and QoS as usage approaches or exceeds the spending limit, so there may be multiple notifications of rates and QoS for a session as they change.

After the notification is sent, UE 150 displays or otherwise provides the notification to the end user. The end user is therefore warned that his/her usage is approaching a spending limit. The end user is also presented with the options for continuing with the session, which he/she can select as desired. After the selection is made by the end user, UE 150 sends a response back to OFCS 110.

OFCS 110 receives the response from the end user that indicates the selected option in step 212. In step 214, OFCS 110 conveys the selected option to a network element (e.g., network element 102). OFCS 110 may also convey other information regarding the spending limit to the network element, such as the actual spending limit, the time period for the spending limit, etc. The network element is then able to modify policies for the session based on the option selected by the end user. For example, if the end user selects the option to downgrade the QoS for the session, then the network element is able to modify policies for the session such that the QoS is reduced. If the end user selects the option to upgrade the QoS for the session, then the network element is able to modify policies for the session such that the QoS is temporarily raised for a higher rate.

By defining a spending limit for offline charging, OFCS 110 is able to alert an end user when a spending limit is near, and can take actions to modify a session to avoid the spending limit being reached or at least delay when the spending limit is reached. Therefore, the end user is less likely to receive a bill at the end of a billing cycle that is significantly more than the end user expected.

### Example

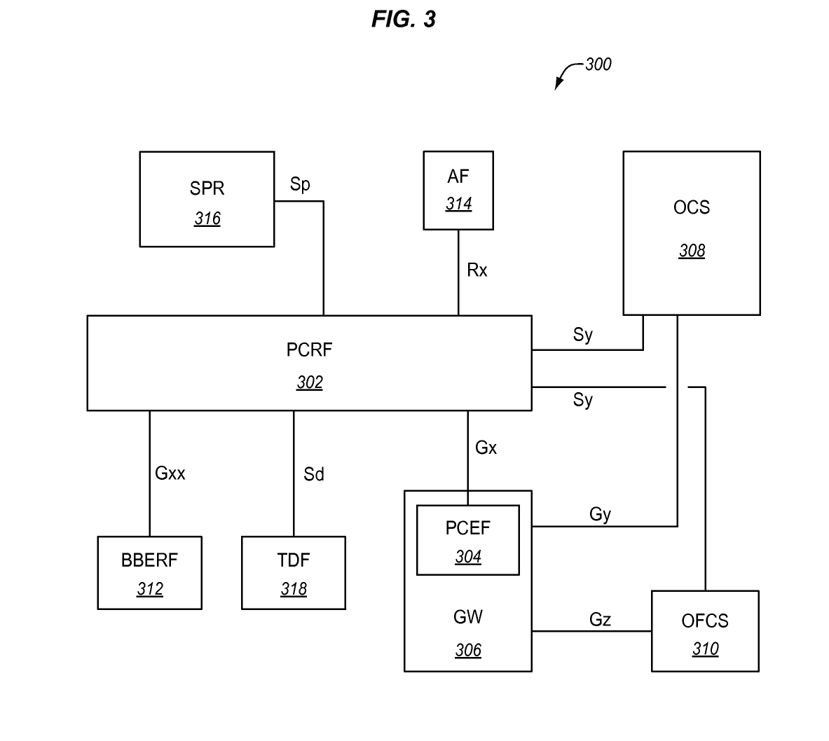

FIG. 3 illustrates a Policy and Charging Control (PCC) architecture 300 for a packet core network in an exemplary embodiment. The PCC architecture 300 may be used in a Long Term Evolution/Evolved Packet Core (LTE/EPC) network or another type of 4G network. PCC architecture 300 includes a Policy and Charging Rules Function (PCRF) 302 and a Policy and Charging Enforcement Function (PCEF) 304 that together provide a Policy and Charging Control (PCC) solution for a packet core network.

PCRF 302 encompasses policy control decision and flow-based charging control functionalities. Therefore, PCRF 302 is a node of the packet core network that generates PCC rules for a requested service, which is referred to as a PCC decision. PCRF 302 may include a policy engine (not shown) that makes the PCC decision. Although the term “PCRF” is used in this description, the functionality of PCRF 302 is applicable to any network node that makes policy decisions in a packet core network.

PCEF 304 encompasses service data flow detection, policy enforcement, and flow-based charging functionalities. Therefore, PCEF 304 is a node of the packet core network that enforces the PCC rules for the requested service. For example, PCEF 304 may set up bearer connections for the service, modify existing bearer connections, ensure that only authorized service data flows are established, ensure that QoS limits are not exceeded, etc.

PCEF 304 is typically implemented in a gateway (GW) 306, such as a packet data gateway (P-GW) in an EPC network. PCC architecture 300 further includes an Online Charging System (OCS) 308, an Offline Charging System (OFCS) 310, a Bearer Binding and Event Reporting Function (BBERF) 312, an application function (AF) 314, a Subscriber Profile Repository (SPR) 316, and a Traffic Detection Function (TDF) 318. OCS 308 provides online charging for services/sessions accessed by end users. In addition, OCS 308 stores charging rules/plans for the end users which PCRF 302 may use when making a PCC decision. For example, charging rules may define that an end user is a prepaid subscriber, and may define tariffs for different services requested by the end user. PCRF 302 interfaces with OCS 308 via a Diameter Sy interface or any other protocol to exchange charging rules/plans with OCS 308.

AF 314 is an element offering applications that require dynamic policy and/or charging control. AF 314 communicates with PCRF 302 to transfer dynamic session information used for PCC decisions, and to receive session-specific information and notifications about bearer level events. For example, AF 314 may provide IP-addresses, port numbers, bit rates, delay sensitivity, etc., for requested services to PCRF 302. PCRF 302 may then use this information when making the PCC decision. AF 314 communicates with PCRF 302 via a Diameter Rx interface or other suitable protocol interface. One example of AF 314 is a Proxy-Call Session Control Function (P-CSCF) of the IP Multimedia Subsystem (IMS).

SPR 316 is a logical entity that stores subscriber/subscription related information (i.e., subscriber profiles) used for subscription-based policies, and stores PCC rules generated by PCRF 302. SPR 316 interfaces with PCRF 302 via a Diameter Sp interface or any other protocol used to exchange policy rules with PCRF 302.

TDF 318 is a functional entity that performs application detection, and reports detected applications and their service data flow descriptions to PCRF 302. TDF 318 may also perform gating, redirection, and bandwidth limitation if a service data flow description cannot be provided to PCRF 302.

OFCS 310 provides offline charging for services/sessions accessed by end users. OFCS 310 is enhanced in this embodiment by having a communication link with PCRF 302. The 3GPP defined a communication link between OCS 308 and PCRF 302, but did not define a communication link between OFCS 310 and PCRF 302. The communication link between OFCS 310 and PCRF 302 may be over a Diameter Sy reference point or another suitable reference point.

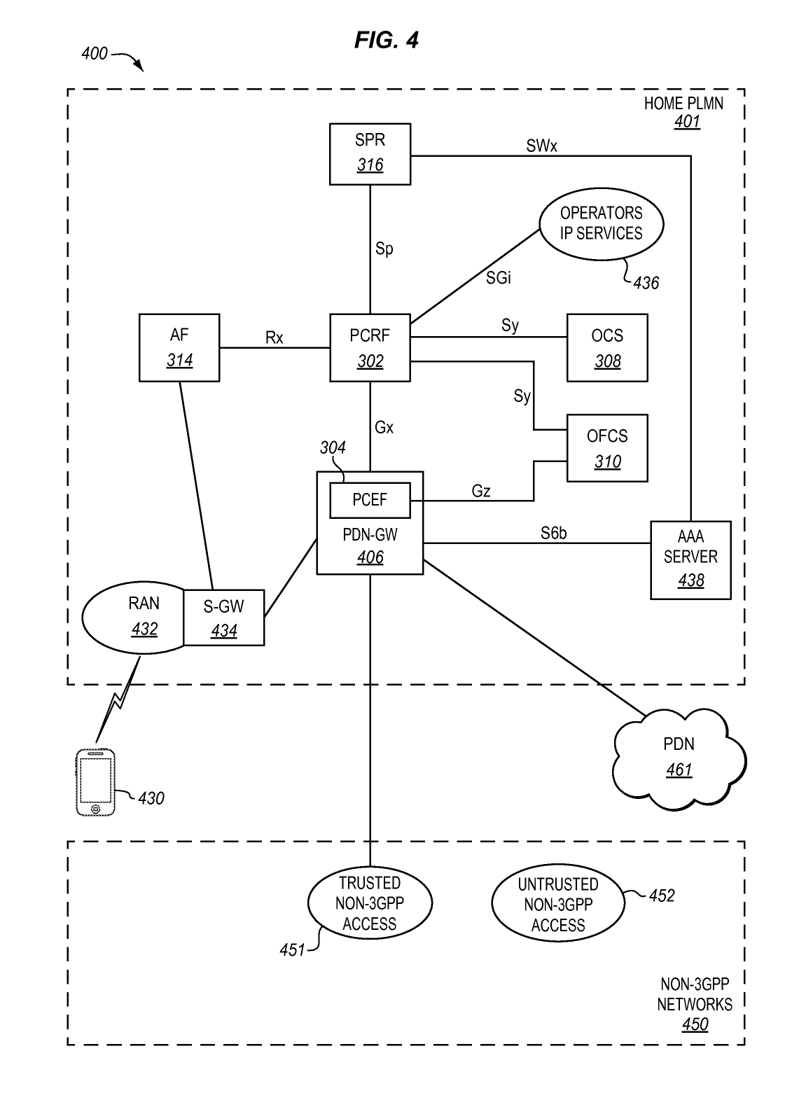

OFCS 310 is also enhanced to provide spending limit control over sessions that are billed using offline charging. OFCS 310 stores and maintains information related to spending limits, and the Sy reference point enables transfer of the information to PCRF 302. The PCC architecture of FIG. 3 may be implemented in an LTE network or another type of 4G network. FIG. 4 illustrates an LTE network 400 using the PCC architecture of FIG. 3 in an exemplary embodiment. LTE network 400 includes a home Public Land Mobile Network (PLMN) 401 and one or more non-3GPP networks 450. Home PLMN 401 represents a packet core network where an end user of a UE 430 has subscribed to a service plan. Home PLMN 401 includes the following nodes of a PCC architecture: PCRF 302, PCEF 304 implemented in a packet data network gateway (PDN-GW) 406, OCS 308, OFCS 310, application function (AF) 314, and SPR 316. In addition, home PLMN 401 includes a 3GPP Radio Access Network (RAN) 432, a serving gateway (S-GW) 434, operator's IP services 436 (e.g., IP Multimedia Subsystem (IMS)), and an Authentication, Authorization and Accounting (AAA) server 438. Non-3GPP network 450 includes a trusted non-3GPP access network 451 and an un-trusted non-3GPP access network 452.

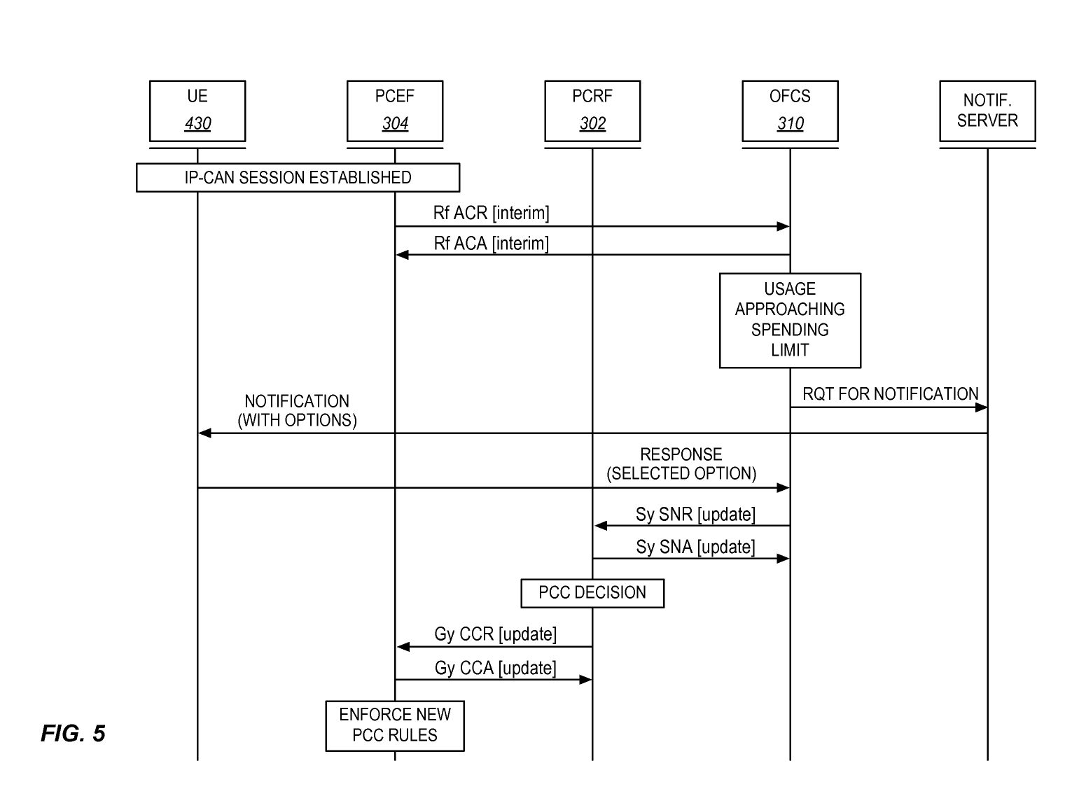

PDN-GW 406 is connected to one or more Packet Data Networks (PDN) 461. When a service data flow is established for a data service, the service data flows are established over the PDN 461. Assume for this embodiment that the end user of UE 430 has subscribed to a service plan with the operator of network 400. The service plan defines the policy rules and the charging rules that will be used in a PCC decision if/when the end user attempts to access a service provided by home PLMN 401. Another assumption is that the end user subscribes to offline charging. The end user may therefore define one or more spending limits for offline charging. For example, the end user may define a spending limit of $100 per billing cycle. OFCS 310 is able to enforce the spending limits as is illustrated in FIG. 5.

In FIG. 4, in order to access a data service, UE 430 sends a request for a data session to RAN 432. The session request includes a description (e.g., Session Description Protocol (SDP) description) of an initial data service being requested. For example, if the initial data service is a VoIP call, then the session description will specify a VoIP call along with other session parameters. PCEF 304 receives the request to initiate or establish a data session from UE 432, and then sends a request for PCC rules to PCRF 302 over the Gx reference point. PCRF 302 is tasked with making a PCC decision for the data session. Therefore, PCRF 302 obtains subscriber data and/or charging rules from SPR 316 over the Sp reference point, and generates PCC rules for the initial data service. PCRF 302 then transmits a response to PCEF 304 that includes the PCC rules for the initial data service.

PCEF 304 then applies the PCC rules to the data session. Applying the PCC rules is also referred to as enforcing the PCC decision. When applying the PCC rules, PCEF 304 enforces policy control through gate enforcement and QoS enforcement, and enforces charging control based on the charging method, which is offline charging in this example. Thus, PCEF 304 establishes the service data flow and collects charging information. PCEF 304 then interfaces with OFCS 310 and sends the offline charging information to OFCS 304. As the data session is active, OFCS 310 is able to enforce the spending limits defined for the end user of UE 430 as is further illustrated in FIG. 5.

FIG. 5 is a message diagram illustrating an example of spending limit control for offline charging in an exemplary embodiment. As the IP-CAN session is active and one or more service data flows are initiated, PCEF 304 periodically sends a Diameter Rf Accounting Request (ACR) [interim] to OFCS 310 with charging information for the session. OFCS 310 responds to the ACRs with a Diameter Rf Accounting Answer (ACA) [interim]. Although only one ACR[interim] is shown in FIG. 5, those skilled in the art understand that PCEF 304 periodically sends an ACR to OFCS 310 while the session is active. Also, network elements may send CDRs to OFCS 310 along with or instead of ACRs.

OFCS 310 stores a spending limit for the end user, and also maintains one or more policy counters for the end user. A policy counter tracks the usage of the end user over a time period. For example, a policy counter may be cleared at the beginning of a billing cycle. As the end user places voice calls, surfs the internet, plays an online game, etc., the policy counter increments based on the usage of the end user during the billing cycle. OFCS 310 therefore monitors the usage of the end user during the billing cycle based on the charging information included in the ACRs (for the present session and other session established during the billing cycle) by incrementing the policy counter(s).

While monitoring the policy counter during the present session, OFCS 310 determines that the usage of the end user is approaching the spending limit defined for the end user. For example, if the spending limit is $100, OFCS 310 may determine that the usage is approaching the spending limit when the usage reaches $80, $90, or some spending threshold that is less than the spending limit. When this occurs, OFCS 310 identifies options for the end user to continue with the session. For example, the options may be for the end user to continue with the session in its present form (i.e., the same QoS at the same rate), to downgrade the QoS for the session (at the same rate or at a reduced rate), to upgrade the QoS for the session at a higher rate, or to maintain the QoS for the session at a higher rate. There may be multiple other options available to an end user when a spending limit is near.

OFCS 310 then requests that a notification server (not shown) transmits a notification to UE 430. The notification to UE 430 may include a total usage (e.g., monetary, volume, duration) for the present billing cycle. In other words, the notification may indicate the present status of the policy counter for the billing cycle. The notification may also include a present rate for the session, a present QoS for the session, a future rate for the session if the spending limit is reached, a future QoS for the session if the spending limit is reached, and the options for the end user. The notification therefore alerts the end user that the spending limit is approaching, and also provides options for the end user to continue with the present session or future sessions during the billing cycle as the spending limit is near or reached.

The end user may then select one of the options. Or alternatively, UE 430 may be provisioned with a default selection, which is considered a selection by the end user. UE 430 then conveys the selection by the end user to OFCS 310. After the selection by the end user, OFCS 310 sends information related to the spending limit to PCRF 302. OFCS 310 sends a Diameter Subscribe-Notification-Request (SNR) to PCRF 302 over the Diameter Sy interface with the desired information. The SNR includes the option selected by the end user, and may also include the present status of the policy counter or other data. PCRF 302 responds to OFCS 310 with a Diameter Subscribe-Notification-Answer (SNA).

When receiving the information from OFCS 310, PCRF 302 triggers a new PCC decision. Therefore, PCRF 302 processes the information related to the spending limit, including the option selected by the end user, to generate new PCC rules for the session. For example, if the end user selected the option to downgrade QoS for the session, then PCRF 302 will authorize a lower QoS in the new PCC rules.

PCRF 302 then sends the new PCC rules to PCEF 304 in a Diameter Credit Control Request (CCR). PCEF 304 responds to PCRF 302 with a Diameter Credit Control Answer (CCA). PCEF 304 then enforces the new PCC rules for the session. For example, if the end user selected the option to downgrade QoS for the session, then PCEF 304 will enforce a lower QoS for the session.

As is shown in FIG. 5, OFCS 310 is able to enforce a spending limit on the end user during a billing cycle. Thus, it is less likely that the end user of UE 430 will receive a bill at the end of the billing cycle that is much higher than what was expected.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as non-transitory instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

1. A system comprising:
an offline charging system configured to monitor usage of an end user over a packet core network based on accounting information, to identify a spending limit that the end user is allowed to consume during a time period, to determine that the usage of the end user is approaching the spending limit during a session, to identify options for the end user to continue with the session as the usage of the end user approaches the spending limit, and to initiate a notification to the end user indicating the options;
the offline charging system is further configured to receive a response from the end user selecting one of the options, and to convey the selected option to a network element in the packet core network that modifies policies for the session based on the selected option.

2. The system of claim 1 wherein:
the options include downgrading a Quality of Service (QoS) for the session at the same rate or a lower rate.

3. The system of claim 1 wherein:
the options include upgrading a Quality of Service (QoS) for the session at a higher rate.

4. The system of claim 1 wherein:
the options include maintaining a Quality of Service (QoS) for the session at a higher rate.

5. The system of claim 1 wherein:
the options include maintaining a Quality of Service (QoS) for the session at the same rate.

6. The system of claim 1 wherein:
the network node comprises a Policy and Charging Rules Function (PCRF); and
the offline charging system communicates with the PCRF over a Diameter Sy interface.

7. A method comprising:
monitoring, in an offline charging system, usage of an end user over a packet core network based on accounting information;
identifying a spending limit that the end user is allowed to consume during a time period;
determining that the usage of the end user is approaching the spending limit during a session;
identifying options for the end user to continue with the session as the usage of the end user approaches the spending limit;
transmitting a notification to the end user indicating the options;
receiving a response in the offline charging system from the end user selecting one of the options; and
conveying the selected option from the offline charging system to a network element in the packet core network that modifies policies for the session based on the selected option.

8. The method of claim 7 wherein:
the options include downgrading a Quality of Service (QoS) for the session at the same rate or a lower rate.

9. The method of claim 7 wherein:
the options include upgrading a Quality of Service (QoS) for the session at a higher rate.

10. The method of claim 7 wherein:
the options include maintaining a Quality of Service (QoS) for the session at a higher rate.

11. The method of claim 7 wherein:
the options include maintaining a Quality of Service (QoS) for the session at the same rate.

12. The method of claim 7 wherein conveying information regarding the spending limit from the offline charging system to the network element comprises:
conveying the information regarding the spending limit over a Diameter Sy interface.

13. A system comprising:
an offline charging system that connects to a Policy and Charging Rules Function (PCRF) of a packet core network;
the offline charging system is configured to monitor usage of an end user over a packet core network based on accounting information, to identify a spending limit that the end user is allowed to consume during a time period, to determine that the usage of the end user is approaching the spending limit during a session, to identify options for the end user to continue with the session as the usage of the end user approaches the spending limit, and to initiate a notification to the end user indicating the options;
the offline charging system is further configured to receive a response from the end user selecting one of the options, and to convey the selected option to the PCRF to modify Policy and Charging Control (PCC) rules for the session based on the selected option.

14. The system of claim 13 wherein:
the offline charging system communicates with the PCRF over a Diameter Sy interface.

15. The system of claim 14 wherein:
the offline charging system is further configured to convey the information regarding the spending limit to the PCRF in a Subscribe-Notifications-Request (SNR) over the Diameter Sy interface.

16. The system of claim 13 wherein:
the options include downgrading a Quality of Service (QoS) for the session at the same rate or a lower rate.

17. The system of claim 13 wherein:
the options include upgrading or maintaining a Quality of Service (QoS) for the session at a higher rate.

18. The system of claim 13 wherein:
the notification further includes a present Quality of Service (QoS) for the session and a new QoS for the session if the usage exceeds the spending limit.

19. The system of claim 13 wherein:
the notification further includes a present rate for the session and a new rate for the session if the usage exceeds the spending limit.

20. The system of claim 13 wherein:
the PCRF is configured to process the selected option to generate the modified PCC rules for the session, and to transmit the modified PCC rules to a Policy and Rules Enforcement Function (PCEF).
